(19) United States
(12) Patent Application Publication
(10) Pub. No.: US 2006/0224523 A1
(43) Pub. Date: Oct. 5, 2006

(54) Dynamic keypad

(76) Inventor: Rajith Tharanga Elvitigala, Horana (LK)

Correspondence Address: FAY KAPLUN & MARCIN, LLP, 15O BROADWAY, SUITE 702, NEW YORK, NY, 10038, US

(21) Appl. No.: 11/095,824

(22) Filed: Mar. 31, 2005

(51) Int. Cl. G06Q 99/00

(52) U.S. Cl. 705/64; 705/71

(57) ABSTRACT

Methods and apparatus for providing a dynamic interface, for example, a keypad on a touch screen. When the touch screen displays a keypad, the appearance of the keypad is randomly generated. In an embodiment, consecutive keypads can differ with respect to any combination of the size of the keys, the shape of the keys, the spacing between the keys and the position of the keypad on the screen. Additionally, at least some part of a generated keypad appearance can be determined from a previous user's input.

### FIELD OF THE INVENTION

The invention is directed to user interfaces and, more particularly to a dynamic keypad.

### BACKGROUND OF THE INVENTION

Many ATMs (automatic teller machines), vending machines, computer devices, personal computers, Point of sale (POS) terminals, etc., use touch screens to interface with users. Touch screens are useful because they allow a computer to display a number of different interfaces on the same display. For example, an ATM can use the same monitor to display a numbered keypad for entering a PIN (personal identification number), and for displaying an authorized user's bank records. Such an ATM does not require a separate physical keypad, with a plurality of buttons that need to be maintained. Additionally, the absence of a physical keypad allows an ATM to be smaller in size or have a larger monitor.

Unfortunately, touch screens are vulnerable to overlay attacks by criminals hoping to steal someone's PIN or password and access their personal information. An overlay attack involves determining a person's key strokes by placing an overlay on the monitor. The overlay can be a thin plastic cover that looks like a protective sheet that safeguards the display. In reality, the plastic cover can include electronics that record the key strokes of a user. The overlay can store the keystrokes for later retrieval and/or a thief can remotely monitor the stolen keystrokes. Other overly attacks include taking fingerprints after applying a thin layer of oil to the display.

Accordingly, there is a desire for methods and apparatus that can combat overlay attacks on manifested interfaces, such as, for example, an electronic keypad. Additionally, it is preferable if the protective methods and apparatus will continue to work with future manifested interface technologies, such as, for example, laser projection displays, holographic display, etc.

### SUMMARY OF THE INVENTION

The invention as described and claimed herein satisfies this and other needs, which will be apparent from the teachings herein.

An exemplary interface implemented in accordance with the invention comprises a plurality of keys representing a predefined set of characters. The appearance of the keys in the manifested keypad is randomly generated. The appearance of consecutively displayed keypads can differ in size, shape, spacing, positioning, etc. These dynamic keypads protect against overlay attacks by disassociating a user's keystroke with a particular character.

In an embodiment of the invention, a keypad user's input, such as, for example, a PIN, can be saved by a keypad display device and used as a seed to randomly generate a following keypad's appearance. The following keypads can be selected from a plurality of predefined keypad appearances and/or the following keypads can be generated using at least one seed and at least one algorithm. For example, a first seed can be applied to a first algorithm to determine the size of the keys, and a second seed can be applied to a second algorithm to determine the position of the keypad. The seeds can be computer generated random numbers and/or saved user inputs from previous users.

Embodiments of the invention can be implemented as devices, such as, for example, ATMs and portable computers. Any device, implemented in accordance with an embodiment of the invention, that manifests an interface can use a dynamic interface to protect against overlay attacks and other similar attacks.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIGS. 1-5 illustrate five keypad layouts implemented in accordance with an embodiment of the invention.

FIG. 6 illustrates an exemplary device that can execute an exemplary operation of a dynamic keypad method implemented in accordance with an embodiment of the invention.

FIG. 7 illustrates an exemplary dynamic keypad method implemented in accordance with an embodiment of the invention.

### DETAILED DESCRIPTION OF EXEMPLARY EMBODIMENTS

There will now be shown and described in connection with the attached drawing figures several exemplary embodiments of methods and apparatus for providing a dynamic keypad.

Many computers, machines, etc. use manifested interfaces, such as, for example, a touch screen displaying a keypad, to receive input from users. Manifested interfaces are convenient because the same display area can be used to show a plurality of different screens and/or interfaces. For example, an ATM can use a first interface on a screen to receive a PIN from a customer and use a second interface on the same screen to show the customer their bank records.

Unfortunately, touch screens and other manifested interfaces are susceptible to overlay attacks. For example, a thin layer, which can record a person's keystrokes, is placed on top of a touch screen. Since keypads in devices that use known manifested interfaces are static, in other words the position of the keypad and the size of the keys are the same for each device user. Overlay attackers can determine a person's PIN by correlating the person's keystrokes with the static keypad.

Therefore, in order to combat overlay attacks, an embodiment of the invention provides a dynamic keypad, which can change characteristics after each use. For example, in an embodiment, the position of the entire keypad can move randomly around a display area after each use. Since the keys are moving around, an overlay attacker will not be able to correlate key strokes with keys. Other methods of changing the characteristics of the key pad include, but are not limited to, changing the size of the keys, changing the shape of the keys, changing the spacing between the keys, etc. Additionally, any combination of characteristic changes can be used to further randomize the appearance of the keypad.

In an embodiment of the invention, the current keypad characteristics can be randomly selected by using, for example, previous user inputs as seeds to functions that determine all or some of the characteristics of the current keypad. Since users have private numbers it is very difficult to predict the appearance of the current or next keypad. In other embodiments, at least part of the current keypad characteristics can be determined from a computer generated seed, so that an overlay attacker cannot “set up” a machine by using it several times themselves.

The functions that select the appearance of the current keypad can be as simple or complicated as a machine supervisor desires. For example, a simple function can comprise using a computer generated pseudo random to choose from a predetermined set of keypad appearances.

An alternate algorithm can comprise using at least one computer generated random number and/or previous user inputs with a plurality of functions for determining the characteristics of a current keypad. For example, in an embodiment, one random number can be applied to a function that determines the size of the keys, and another random number can be used to determine the space between the keys, and yet another random number can be used to determine the position of the entire keypad on the display. The functions can choose the size of the keys, the spacing between the keys and the position of the keypad from a predefined pool, and/or the functions can provide a value that is used to set the characteristics of the keypad.

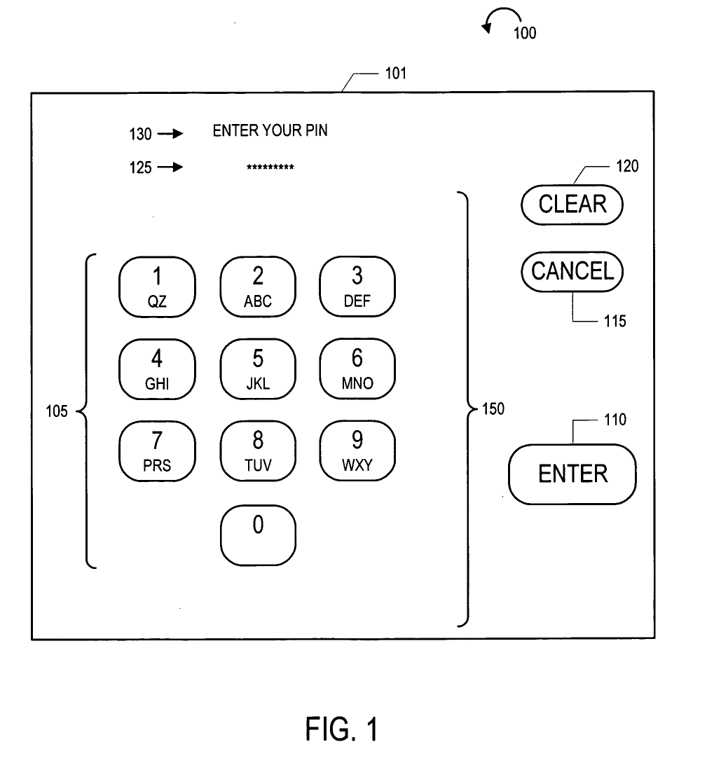

FIGS. 1-5 illustrate five exemplary configurations for a keypad 105. The keypads in FIGS. 1-5 are exemplary embodiments that may be used in an embodiment of the invention, and the invention is not limited to the examples illustrated in FIGS. 1-5. FIG. 1 illustrates an exemplary manifested interface 100, which can be displayed by a display module 101, such as, for example, a touch screen monitor. The interface 100 comprises a keypad 105, which has a layout similar to a telephone keypad, i.e., the keypad 105 comprises ten keys numbered 0-9 and some of the keys also represent different letters of the alphabet. Other keypads comprise, but are not limited to, a calculator layout, a keyboard layout, etc. The manifested interface 100 also comprises a clear button 120, a cancel button 115, an enter button 110, instructions 130 and an input display 125.

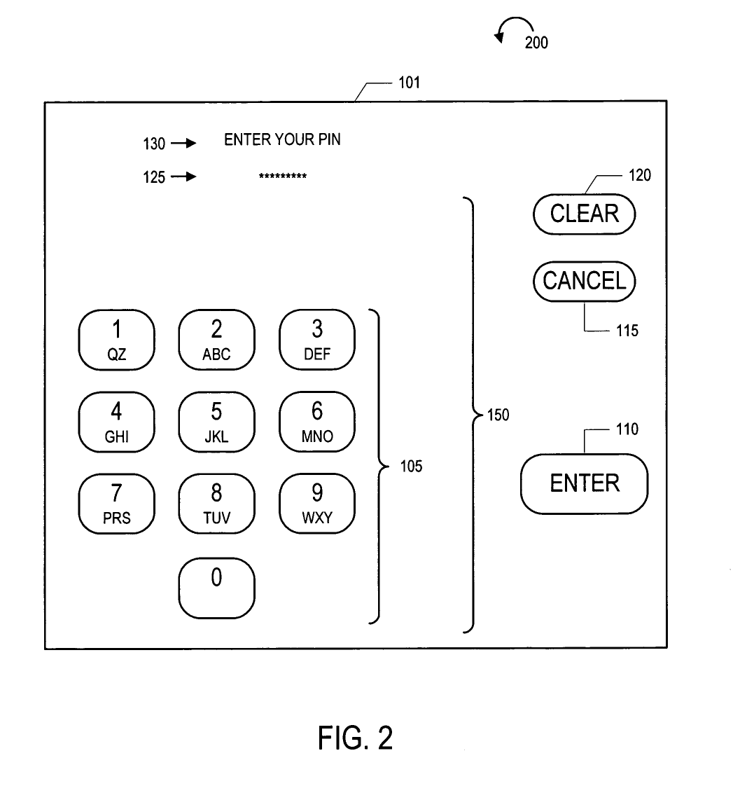

The manifested interface 100 illustrated in FIG. 1, positions the keypad 105 in the center of a display area 150. The manifested interface 200 illustrated in FIG. 2, positions the keypad 105 in the lower left hand corner of the display area 150. Since the keypad has shifted, an overlay attacker cannot tell which keypad a particular user was shown and thus cannot correlate keystrokes to keypad numbers. Whether a user presses a “5” or a “3” depends on the keypad that was shown to the user. Thus, a sufficiently random keypad appearance can prevent overlay attackers from correlating keystrokes and numbers, because the generated appearance of the keypad is unknown.

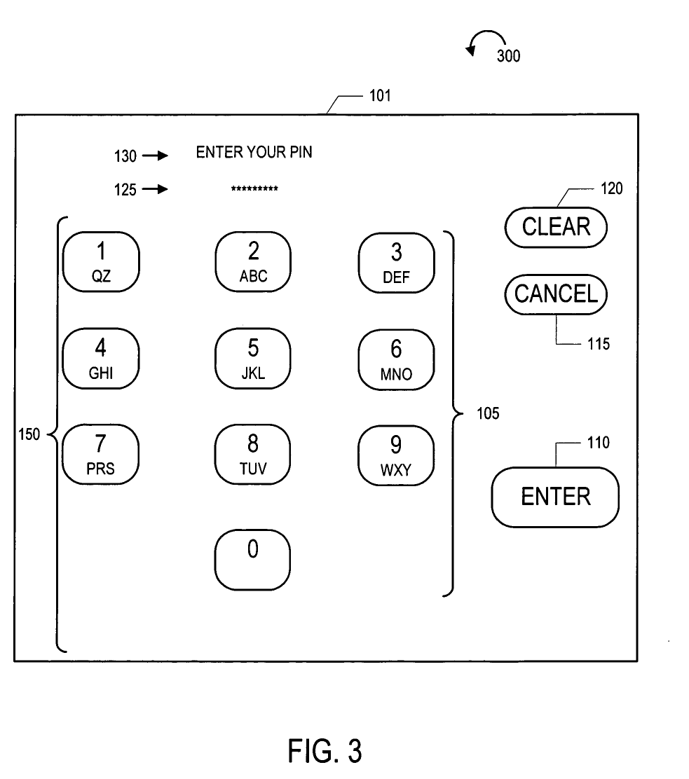

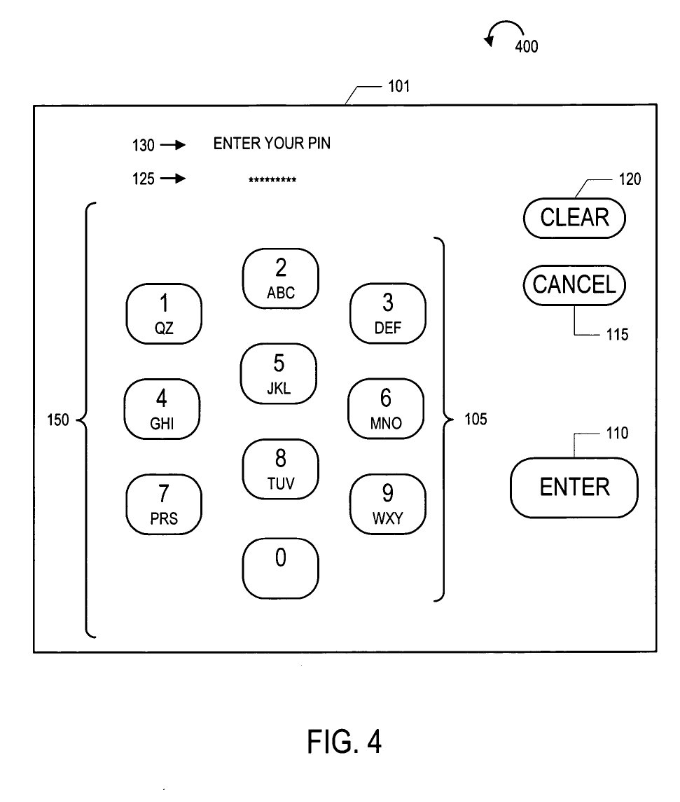

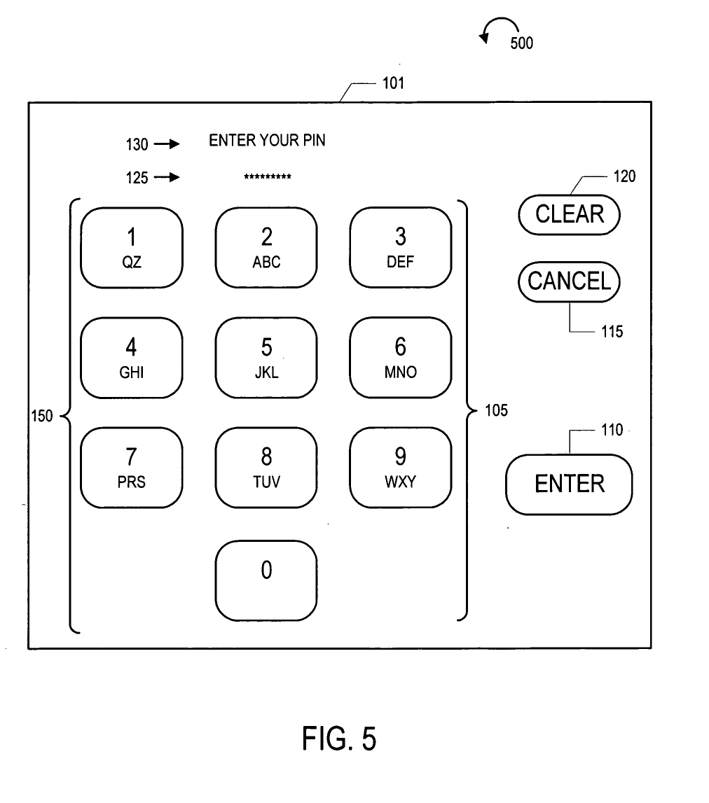

FIG. 3 illustrates an alternate manifested interface 300. In FIG. 3, the keys of keypad 105 are spaced out to fill the entire display area 150. In the manifested interface 400 illustrated in FIG. 4, the center column of keys in keypad 105 has been shifted up in relation to the left and right columns. In FIG. 5, the keypad of manifested interface 500 has extra large keys. Other keypad configuration include, but are not limited to, flipping the position of the keypad 105 and the clear 120, cancel 115 and enter 110 buttons; changing the shape of the buttons; changing the order of the buttons; etc.

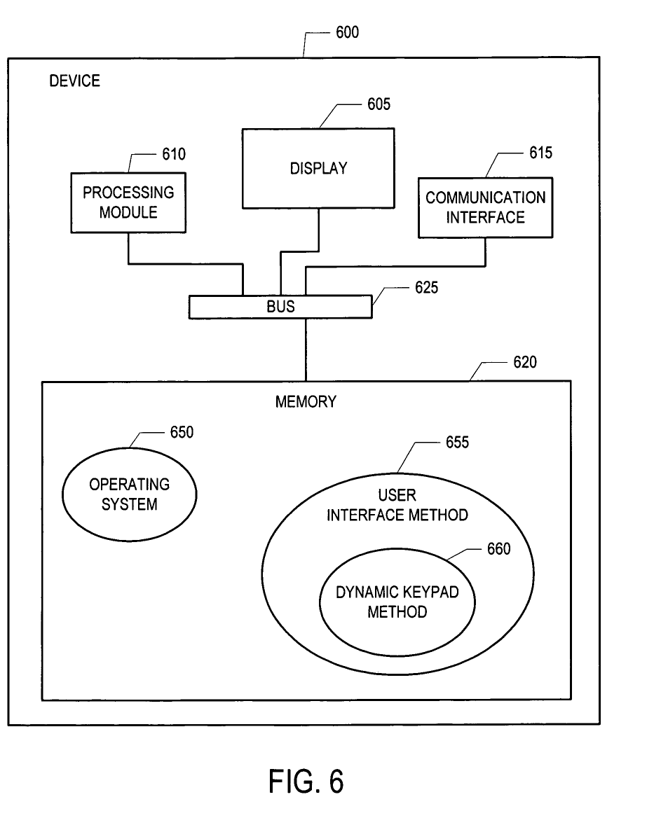

FIG. 6 illustrates an exemplary device 600, which is implemented in accordance with an embodiment of the invention. The device 600 comprises a processing module 610, a display 605, a communication interface 615 and memory 620 coupled together by bus 625. The modules of device 600 can be implemented as any combination of software, hardware, hardware emulating software, and reprogrammable hardware. The bus 625 is an exemplary bus showing the interoperability of the different modules of the invention. As a matter of design choice there may be more than one bus and in some embodiments certain modules may be directly coupled instead of coupled to a bus 625. Additionally, in alternate embodiments of the invention, the modules of device 600 can be located externally to the device 600. The device 600 can be, for example, an ATM machine, a PDA, a laptop, a Point of Sale (POS) terminal, etc.

Processing module 610 can be implemented as, in exemplary embodiments, one or more Central Processing Units (CPU), Field-Programmable Gate Arrays (FPGA), etc. In an embodiment, the processing module 610 may comprise a plurality of processing units or modules. Each module can comprise memory that can be preprogrammed to perform specific functions, such as, for example, signal processing, interface display, etc. Processing module 610 can also comprise any combination of the processors described above.

Display module 605 can be implemented in alternate embodiments as a CRT monitor, an LCD display, a projection display, etc. The display module 605 can receive user inputs to a manifested user interface displayed by the device 600. Although display module 605 is illustrates as part of device 600, in alternate embodiments, the display module 605, may be externally coupled to device 600, for example through communication interface 615.

Communication interface 615 allows the device 600 to communicate with external peripherals, other devices, communication networks, etc. Communication interface 615 may comprise a plurality of different ports for a plurality of different communication interfaces. In some embodiments, communication interface 615 can be implemented as an antenna, which the device 600 can use to wirelessly communicate with other devices.

The device 600 can use communication interface 615 to receive user information. For example, when device 600 is implemented as an ATM 600, user bank records are retrieved from a remote location. Thus, ATM 600 can use communication interface 615 to retrieve user information. Additionally, a device 600 can use communication interface 615 to receive keypad display instructions.

Memory 120 can be implemented as volatile memory, non-volatile memory and rewriteable memory, such as, for example, Random Access Memory (RAM), Read Only Memory (ROM) and/or flash memory. The memory 120 stores methods and processes used to operate the device 101, such as, for example, operating system 650 and user interface method 655. In some embodiments, a device 600 may not need an operating system 650.

The device 600 utilizes user interface method 655 to receive instructions from a device user and to relay information to the user. For example, user interface method 655 can be used to retrieve a PIN from a user. The PIN can be a personal code to a bank account, a password, etc. Once the user has been authorized, user interface method 655 can retrieve information related to the user and display the information to the user.

In accordance with an embodiment of the invention, user interface method 655 can comprise dynamic keypad method 660. Dynamic keypad method 660 determines the appearance of a keypad that will be used by the device 600 to receive information from a user.

The exemplary embodiment of FIG. 6 illustrates dynamic keypad method 660 as being included in user interface method 655, but those methods are not limited to this configuration. Each method described herein, in whole or in part, can be separate components or can interoperate and share operations. The methods described herein can also comprise a combination of methods. Additionally, although the methods are depicted in the memory 620, in alternate embodiments the methods can be incorporated permanently or dynamically in the memory of processing module 610.

Memory 620 is illustrated as a single module in FIG. 6, but in some embodiments the device 600 can comprise more than one memory module. For example, the methods described above can be stored in separate memory modules. Additionally, some or all parts of memory 620 may be integrated as part of processing module 605.

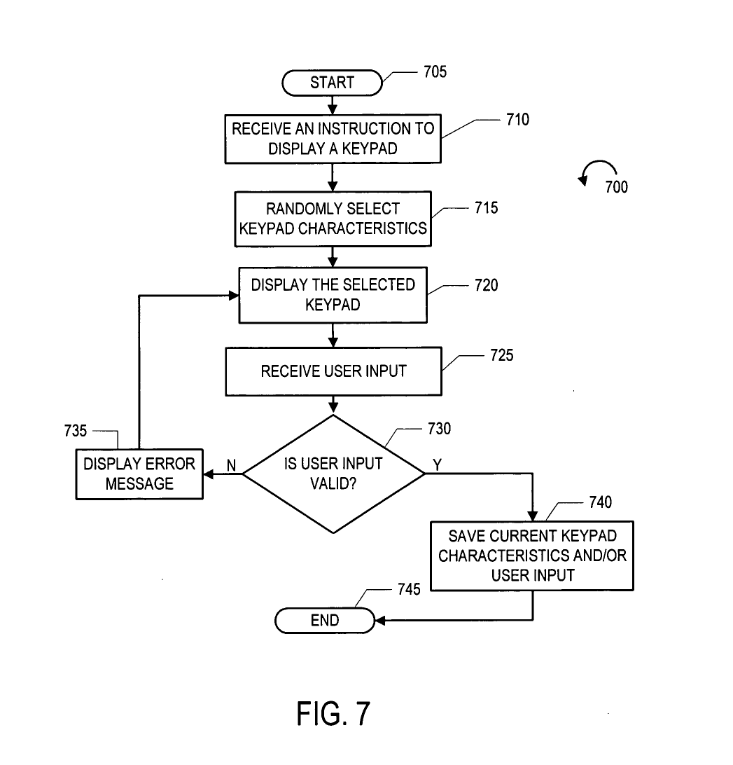

FIG. 7 illustrates an exemplary dynamic keypad method 700 implemented in accordance with an embodiment of the invention. Dynamic keypad method 700 can be executed, in an exemplary embodiment, on a device, such as, for example device 600. Dynamic keypad method 700 starts in step 705, for example when a user starts a device, or when a peripheral device receives an instruction from another computer. For example, a signature capture device can receive an instruction from a cash register to verify a PIN and capture a signature.

Processing proceeds from step 705 to step 710, where the device 600 receives an instruction to display a keypad. This instruction can come from a user interface method 655, for example, as a function call while the method 655 is building an interface to output on a display module 605, and/or the instruction can come for some other process in the device 600.

Following step 710, processing proceeds to step 715, where the device 600 randomly selects the keypad appearance, for example its position, shape, size, orientation, etc. The appearance of the keypad can be determined from the following function:
RB(n)=f₀(z)+f₁(EP(n−1))+f₂(EP(n−2))+f₃(EP(n−3))+ . . . ,

Where:

n=The current keypad

RB(n)=Dynamic keypad display for n^{th} keypad

EP(n−1)=Encrypted Pin of (n−1)^{th} Pin entry

f_{y}(x)=Keypad display function

z=Computer generated pseudo random number.

RB(n) is an exemplary function that may be used to randomly select the appearance of a keypad. In alternate embodiments, the same randomly generated number, z, can be used for all the functions, f_{y}(x), or a different randomly generated number, za, can be chosen for each function, f_{y}(x). In alternate embodiments, RB(n) can comprise a single function, f_{y}(x). Additionally, although the functions f₁(x), f₂(x) and f₃(x), use past user inputs in sequential order, in alternate embodiments, the seed for those function can be obtained pseudo-randomly, remotely from another computer, and/or from any known or future developed method of producing a random seed.

The function, f_{y}(x), can be implemented in a plurality of ways. For example, in an embodiment, the function, f_{y}(x), can take a seed, such as, for example, a number, a letter, a binary sequence, etc., and output a predetermined keypad appearance, such as, for example, any keypad illustrated in FIG. 1-5.

In other embodiments, the function, f_{y}(x), can take a seed and output a characteristic of the keypad. For example, f₀(x) can determine the size of the keys, f₁(x) can determine the space between keys and f₂(x) can determine the position of the keypad on the display. The functions, f_{y}(x), can select from a predetermined set of characteristics, for example, small, medium, or large buttons. Alternatively, the functions, f_{y}(x) can calculate characteristic measurement, for example, given a seed if 1011, a button has a length of 3 cm. The keypad can also be constructed from a combination of calculating characteristic measurements, and selecting from a predetermined set of characteristics.

Once the appearance of the keypad is determined in step 715, processing proceeds from step 715 to step 720. In step 720, the selected keypad is displayed to the user. Then, in step 725, an input from the user is received.

Following step 725, in step 730, the device 600 determines if the user input is valid. This may comprise matching the input to a stored password, determining if the input makes logical sense, etc. In some embodiments, user verification can be performed at a remote location.

If the user input is not correct, processing proceeds to step 735, where the device can display an error message. Processing then returns to step 720, where the device 600 displays the selected keypad to give the user another try to correctly input their information. In some embodiments the device 600 can give a user a certain number of chances before ending the method. Returning to step 735 in an alternate embodiments of the invention, processing can proceed from step 735 to step 715, and a new keypad appearance can be determined.

Returning to step 730, if the user input is valid, processing proceeds from step 730 to step 740. In step 740, the device 600 saves the current keypad characteristics and/or user inputs, in order to use them as seeds to create the next keypad and to avoid duplicate consecutive keypads. In order to protect user inputs, the device 600 can encrypt the inputs before saving them. After the information is saved the method 700 ends in 745. In an embodiment of the invention the method 700 can return to a user interface method that continues to interface with a user.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of providing a dynamic interface comprising:
receiving an instruction to display an interface;
generating an interface appearance, wherein said interface appearance is chosen sufficiently randomly; and
displaying said selected interface appearance.

2. The method of claim 1, wherein the step of generating an interface appearance comprises setting at least one of a key size of said interface, a key shape of said interface, a key spacing of said interface and an interface screen position.

3. The method of claim 1, further comprising:
saving an input of an interface user, wherein said input can be used as a seed when generating a following interface appearance.

4. The method of claim 1, wherein the step of generating an interface appearance comprises selecting an interface appearance from a plurality of predefined interface appearances.

5. The method of claim 1, wherein the step of generating an interface appearance comprises creating an interface appearance by applying at least one seed to at least one algorithm.

6. A display device comprising:
a display module;
a processing module; and
memory having stored thereon at least one method, said method providing a dynamic interface comprising,
receiving an instruction to display an interface,
generating an interface appearance, wherein said interface appearance is chosen sufficiently randomly, and
displaying said selected interface appearance.

7. The display device of claim 6, wherein the step of generating an interface appearance comprises setting at least one of a key size of said interface, a key shape of said interface, a key spacing of said input interface and an interface screen position.

8. The display device of claim 6, wherein said method providing a dynamic interface further comprises:
saving an input of an interface user, wherein said input can be used as a seed when generating a following interface appearance.

9. The display device of claim 6, wherein the step of generating an interface appearance comprises selecting an interface appearance from a plurality of predefined interface appearances.

10. The method of claim 6, wherein the step of generating an interface appearance comprises creating an interface appearance by applying at least one seed to at least one algorithm.

11. The method of claim 6, wherein said display device is a point of sale terminal.

12. The method of claim 6, wherein said display device is a kiosk.

13. A manifested keypad comprising:
a plurality of keys representing a predefined set of characters, wherein an appearance of said keys in said manifested keypad is generated in a sufficiently random manner.

14. The manifested keypad of claim 13, wherein at least one of a size of said keys, a shape of said keys, a spacing between keys and a keypad screen position is randomly chosen.

15. The manifested keypad of claim 13, wherein a user input is saved to be used as a seed when generating a following keypad appearance.

16. The manifested keypad of claim 13, wherein the keypad appearance is randomly selected from a plurality of predefined keypad appearances.

17. The manifested keypad of claim 13, wherein the keypad appearance is generated by applying at least one seed to at least one algorithm.

18. The manifested keypad of claim 13, wherein said keypad is part of a point of sale terminal.

19. The manifested keypad of claim 13, wherein said keypad is part of a kiosk.
